(19) United States
(12) Patent Application Publication
(10) Pub. No.: US 2020/0218943 A1
(43) Pub. Date: Jul. 9, 2020

(54) MEDICAL IMAGE PROCESSING DEVICE AND MACHINE LEARNING DEVICE

(71) Applicant: FUJIFILM Corporation, Tokyo (JP)

(72) Inventor: Masaaki OSAKE, Kanagawa (JP)

(73) Assignee: FUJIFILM Corporation, Tokyo (JP)

(21) Appl. No.: 16/820,621

(22) Filed: Mar. 16, 2020

Related U.S. Application Data
(63) Continuation of application No. PCT/JP2018/032970, filed on Sep. 6, 2018.

(30) Foreign Application Priority Data
Oct. 5, 2017 (JP) 2017-195396

(51) Int. Cl. G06K 9/62; G06T 9/00; G06T 7/00; G06K 9/46

(52) U.S. Cl. CPC G06K 9/6262; G06T 9/00; G06T 7/0012; G06T 2207/30004; G06T 2207/20084; G06T 2207/20081; G06K 9/46

(57) ABSTRACT

A medical image processing device including a processor configured to extract a feature value from a medical image; perform recognition processing of the medical image based on the feature value; and provide the feature value and a result of the recognition to a machine learning device that performs learning using the feature value and the result of the recognition as the learning data.

### CROSS-REFERENCE TO RELATED APPLICATIONS

This application is a Continuation of PCT International Application No. PCT/JP2018/032970 filed on Sep. 6, 2018, which claims priority under 35 U.S.0 § 119(a) to Japanese Patent Application No. 2017-195396 filed on Oct. 5, 2017. Each of the above applications is hereby expressly incorporated by reference, in its entirety, into the present application.

### BACKGROUND OF THE INVENTION

### 1. Field of the Invention

The present invention relates to a medical image processing device that generates learning data to be provided to a machine learning device from a medical image, and the machine learning system.

### 2. Description of the Related Art

In machine learning of an image including deep learning, it is necessary to collect learning data used by a machine learning device for learning. However, since a large amount of learning data is generally required for the machine learning device to perform learning, the amount of data collected by the machine learning device is extremely large. Therefore, in a case where the learning data is transmitted to the machine learning device via a communication network, the transmission of the learning data oppresses a communication capacity of the communication network. In order to solve this problem, information required on a reception side can be efficiently transmitted by extracting a feature value of a transmission target image and transmitting the feature value as in an image communication system described in JP 62-068384 A. The feature value (feature) of the image can be extracted by using a convolutional neural network model described in Alex Krizhevsky, Ilya Sutskever, Geoffrey E. Hinton, “ImageNet Classification with Deep Convolutional Neural Networks”, NIPS (Neural Information Processing Systems), 2012.

### SUMMARY OF THE INVENTION

The aforementioned machine learning device performs deep learning by using the feature value provided as the learning data. However, the reliability of the feature value extracted from the image varies depending on contents of an original image. Thus, in a case where all the provided feature values are used in the same manner, the machine learning device will perform inefficient learning.

The present invention has been made in view of the aforementioned circumstances, and an object of the present invention is to provide a medical image processing device capable of providing learning data that can be efficiently learned by a machine learning device and the machine learning device.

A medical image processing device according to an aspect of the present invention is a medical image processing device that generates learning data to be provided to a machine learning device that performs learning by using data related to an image from a medical image. The medical image processing device comprises a feature value extraction unit that extracts a feature value from the medical image, a recognition processing unit that performs recognition processing of an image based on the feature value, and a providing unit that provides, as the learning data, the feature value and a result of the recognition performed by the recognition processing unit to the machine learning device.

A machine learning system according to another aspect of the present invention is a machine learning system that performs learning by using data related to an image to be provided form a medical image processing device. The medical image processing device includes a feature value extraction unit that extracts a feature value from a medical image, a recognition processing unit that performs recognition processing of an image based on the feature value, and a providing unit that provides, as learning data, the feature value and a result of the recognition performed by the recognition processing unit to the machine learning device, and the machine learning device performs the learning by using the learning data.

According to the present invention, it is possible to provide a medical image processing device capable of providing learning data that can be efficiently learned by a machine learning device, and the machine learning device.

### BRIEF DESCRIPTION OF THE DRAWINGS

FIG. 1 is a block diagram showing a relationship between a medical image processing device and a machine learning device according to a first embodiment of the present invention, and configurations thereof.

FIG. 2 is a flowchart showing processing performed by the medical image processing device according to the first embodiment.

FIG. 3 is a block diagram showing a relationship between a medical image processing device and a machine learning device according to a second embodiment of the present invention, and configurations thereof.

FIG. 4 is a flowchart showing processing performed by the medical image processing device according to the second embodiment.

FIG. 5 is a block diagram showing a relationship between a medical image processing device and a machine learning device according to a third embodiment of the present invention, and configurations thereof.

FIG. 6 is a flowchart showing processing performed by the medical image processing device according to the third embodiment.

FIG. 7 is a block diagram showing a relationship between a medical image processing device and a machine learning device according to a fourth embodiment of the present invention, and configurations thereof.

FIG. 8 is a flowchart showing processing performed by the medical image processing device according to the fourth embodiment.

### DESCRIPTION OF THE PREFERRED EMBODIMENTS

Embodiments of the present invention will be described below with reference to the drawings.

### First Embodiment

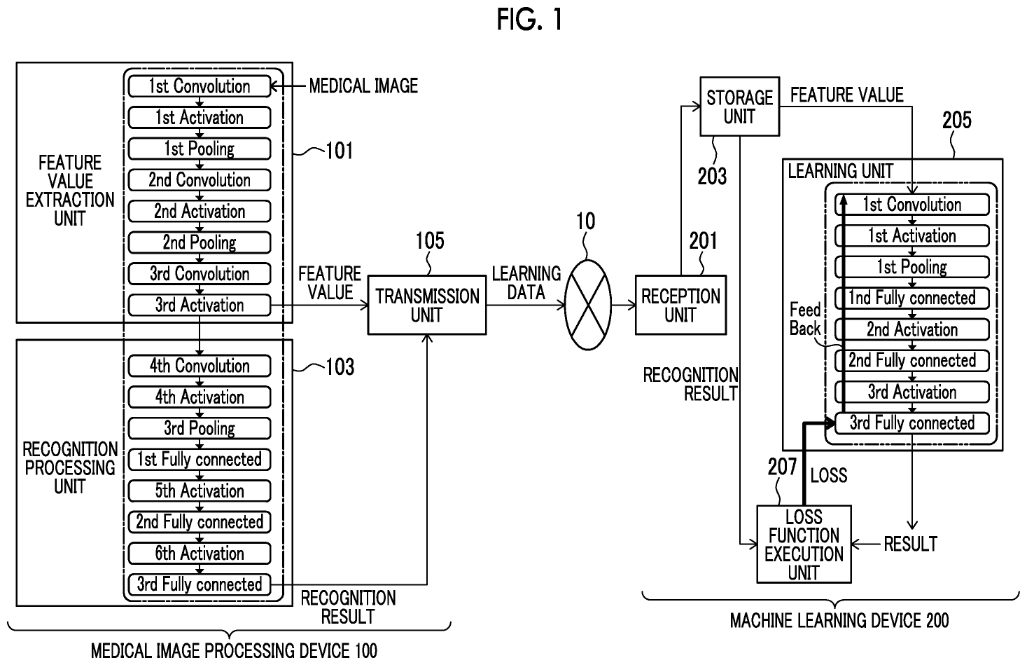

FIG. 1 is a block diagram showing a relationship between a medical image processing device 100 and a machine learning device 200 according to the first embodiment of the present invention and configurations thereof. As shown in FIG. 1, the machine learning device 200 that performs learning by using data related to an image and the medical image processing device 100 according to the first embodiment that transmits learning data to the machine learning device 200 are provided such that at least data communication from the medical image processing device 100 to the machine learning device 200 via a communication network 10 can be performed. The communication network 10 may be a wireless communication network or a wired communication network.

Hardware structures of the medical image processing device 100 and the machine learning device 200 are realized by a processor that performs various processing by executing a program, a random access memory (RAM), and a read only memory (ROM). The processor includes a central processing unit (CPU) which is a general-purpose processor that performs various processing by executing a program, a programmable logic device (PLD) which is a processor capable of changing a circuit configuration after a field programmable gate array (FPGA) is manufactured, or a dedicated electric circuit which is a processor having a circuit configuration specially designed to execute specific processing such as an application specific integrated circuit (ASIC). More specifically, the structures of these various processors are electric circuits in which circuit elements such as semiconductor elements are combined. The processor constituting an evaluation system may be one of various processors, or may be a combination of two or more processors of the same type or different types (for example, a combination of a plurality of FPGAs or a combination of a CPU and an FPGA).

Both the medical image processing device 100 and the machine learning device 200 use a network model having a layer structure in which convolutional neural networks (CNNs) are stacked in multiple layers. The network model generally means a function expressed as a combination of a structure of a neural network and a parameter (so-called “weight”) which is a strength of connection between neurons constituting the neural network, but means a program for performing arithmetic processing based on the function in the present specification.

As represented by a dashed dotted line in FIG. 1, the model of the multilayer CNN used by the medical image processing device 100 has a layer structure in which s a first convolution layer (first Convolution), a first activation function layer (first Activation), a first pooling layer (first Pooling), a second convolution layer (second Convolution), a second activation function layer (second Activation), a second pooling layer (second Pooling), a third convolution layer (third Convolution), a third activation function layer (third Activation), a fourth convolution layer (fourth Convolution), a fourth activation function layer (fourth Activation), a third pooling layer (third Pooling), a first fully connected layer (first Fully connected), a fifth activation function layer (fifth Activation), a second fully connected layer (second Fully connected), a sixth activation function layer (sixth Activation), and a third fully connected layer (third Fully connected) are stacked in order. Hereinafter, the model of the multilayer CNN used by the medical image processing device 100 is referred to as a “first network model”.

As represented by a dashed double-dotted line in FIG. 1, the model of the multilayer CNN used by the machine learning device 200 has a layer structure in which a first convolution layer (first Convolution), a first activation function layer (first Activation), a first pooling layer (first Pooling), a first fully connected layer (first Fully connected), a second activation function layer (second Activation), a second fully connected layer (second Fully connected), a third activation function layer (third Activation), and a third fully connected layer (third Fully connected) are stacked in order. Hereinafter, the model of the multilayer CNN used by the machine learning device 200 is referred to as a “second network model”. The second network model has the layer structure identical to the fourth convolution layer and subsequent layers of the first network model, but may be a neural network having a different layer structure.

In a case where data related to an image is input to the first network model or the second network model, a feature value of the image is extracted by performing convolution processing for the convolution layer, processing using an activation function for the activation function layer, and sub-sampling processing for the pooling layer. In all the fully connected layers, processing for combining a plurality of processing results created in the previous layer into one is performed. The last fully connected layer (third fully connected layer) is an output layer that outputs a recognition result of the image.

The medical image processing device 100 includes a feature value extraction unit 101, a recognition processing unit 103, and a transmission unit 105. Data of a medical image such as an image captured by an imaging device of an endoscope, a computed tomography (CT) image, or a magnetic resonance (MR) image is input to the medical image processing device 100.

The feature value extraction unit 101 extracts a feature value from the input data of the medical image by using the above-described first network model. That is, in a case where the data of the medical image is input to the first convolution layer constituting the first network model, the feature value extraction unit 101 performs processing of the first convolution layer, the first activation function layer, the first pooling layer, the second convolution layer, the second activation function layer, the second pooling layer, the third convolution layer, and the third activation function layer in this order, and extracts an output of the third activation function layer as the feature value. The feature value is information obtained by removing at least a part of a coordinate image of the medical image, and is consequently anonymized information.

The recognition processing unit 103 performs pattern recognition processing of the image by using the first network model based on the feature value extracted by the feature value extraction unit 101, that is, the output of the third activation function layer. That is, in a case where the output (feature value) of the third activation function layer is input to the fourth convolution layer constituting the first network model, the recognition processing unit 103 performs processing of the fourth convolution layer, the fourth activation function layer, the third pooling layer, the first fully connected layer, the fifth activation function layer, the second fully connected layer, the sixth activation function layer, and the third fully connected layer in this order, and outputs the output of the third fully connected layer (output layer) as a pattern recognition result (hereinafter, simply referred to as a “recognition result”) of the image.

The transmission unit 105 (an example of a providing unit) associates the recognition result output from the recognition processing unit 103 with the feature value extracted by the feature value extraction unit 101, and transmits, as learning data of the machine learning device 200, the feature value and the recognition result to the machine learning device 200 via the communication network 10. The transmission unit 105 may perform data compression by the feature value by image compression processing using image characteristics such as Joint Photographic Experts Group (JPEG), and may transmit the compressed data.

The machine learning device 200 includes a reception unit 201, a storage unit 203, a learning unit 205, and a loss function execution unit 207. The learning data transmitted from the medical image processing device 100 via the communication network 10 is input to the machine learning device 200.

The reception unit 201 receives the learning data transmitted from the medical image processing device 100 via the communication network 10. The storage unit 203 stores the learning data received by the reception unit 201.

The learning unit 205 performs the pattern recognition processing of the image by using the above-described second network model from the feature value included in the learning data stored in the storage unit 203, and performs learning corresponding to the result of the loss function execution unit 207. That is, in a case where the feature value read out from the storage unit 203 is input to the first convolution layer constituting the second network model, the learning unit 205 performs the processing of the first convolution layer, the first activation function layer, the first pooling layer, the first fully connected layer, the second activation function layer, the second fully connected layer, the third activation function layer, and the third fully connected layer in this order, and outputs the output of the third fully connected layer (output layer) as a result of the pattern recognition of the image. The learning using the learning unit 205 is performed by adjusting the weight in the second network model according to the output of the loss function execution unit 207 fed back to the learning unit 205.

The loss function execution unit 207 inputs, as parameters, the result output from the learning unit 205 and the recognition result stored in the storage unit 203 associated with the feature value corresponding to the result to a loss function (also referred to as an “error function”), and feeds the obtained output (loss) back into the learning unit 205. The output (loss) of the loss function execution unit 207 indicates a difference between the result output from the learning unit 205 and the recognition result transmitted from the medical image processing device 100 and stored in the storage unit 203.

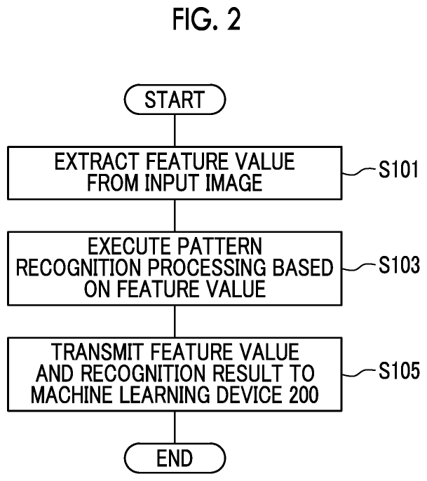

Next, an operation of the medical image processing device 100 according to the first embodiment will be described with reference to FIG. 2. FIG. 2 is a flowchart showing processing performed by the medical image processing device 100 according to the first embodiment.

As shown in FIG. 2, the feature value extraction unit 101 of the medical image processing device 100 extracts the feature value from the input data of the medical image by using the first network model (step S101). Subsequently, the recognition processing unit 103 performs the pattern recognition processing of the image by using the first network model based on the feature value obtained in step S101 (step S103). Subsequently, the transmission unit 105 associates the recognition result obtained in step S103 with the feature value obtained in step S101, and transmits, as the learning data of the machine learning device 200, the feature value and the recognition result to the machine learning device 200 (step S105).

As described above, in the present embodiment, the feature value extracted from the medical image by using the first network model in the medical image processing device 100 and the recognition result derived by using the first network model based on the feature value are provided as the learning data to the machine learning device 200. Thus, the machine learning device 200 can perform efficient learning according to the loss of the result obtained by performing the pattern recognition from the feature value provided as the learning data and the recognition result corresponding to the feature value provided from the medical image processing device 100. That is, the medical image processing device 100 can provide the learning data with which the machine learning device 200 can efficiently learn.

Since a data size of the feature value provided as the learning data to the machine learning device 200 is smaller than a data size of the medical image input to the medical image processing device 100, a communication capacity of the communication network 10 to be used at the time of transmitting the learning data to the machine learning device 200 can be reduced.

It is possible to compress the data size of the learning data to be transmitted to the machine learning device 200 by using, as the feature value, an image (for example, a grayscale image) obtained by appropriately combining colors in a color image, a binary image, an edge-extracted image (a primary differential image or a secondary differential image).

It is possible to ensure anonymity of the medical image on the machine learning device 200 side to which the learning data is provided by using the feature value (for example, a feature value related to a spatial frequency in which coordinate information of the image is partially or completely lost or a feature value obtained by a convolution arithmetic operation) with which the original medical image cannot be visually predicted or recognized. In especially rare cases, there is a possibility that an individual is identified from only the medical image or from the information (for example, a hospital name) limited to the medical image. The anonymity of the medical image means that personal information included in the medical image or information indicating a body or a symptom of the individual obtained by diagnosis cannot be clarified.

Although it has been described in the present embodiment that the learning data is transmitted from the medical image processing device 100 to the machine learning device 200 via the communication network 10, the learning data may be transmitted from the medical image processing device 100 to the machine learning device 200 by using a portable recording medium such as a memory card. Even in this case, since the data size of the feature value provided as the learning data to the machine learning device 200 is smaller than the data size of the medical image input to the medical image processing device 100, it is possible to reduce a storage capacity of the recording medium in which the learning data is recorded. In this case, the processor that controls the recording of the learning data on the recording medium is the providing unit.

### Second Embodiment

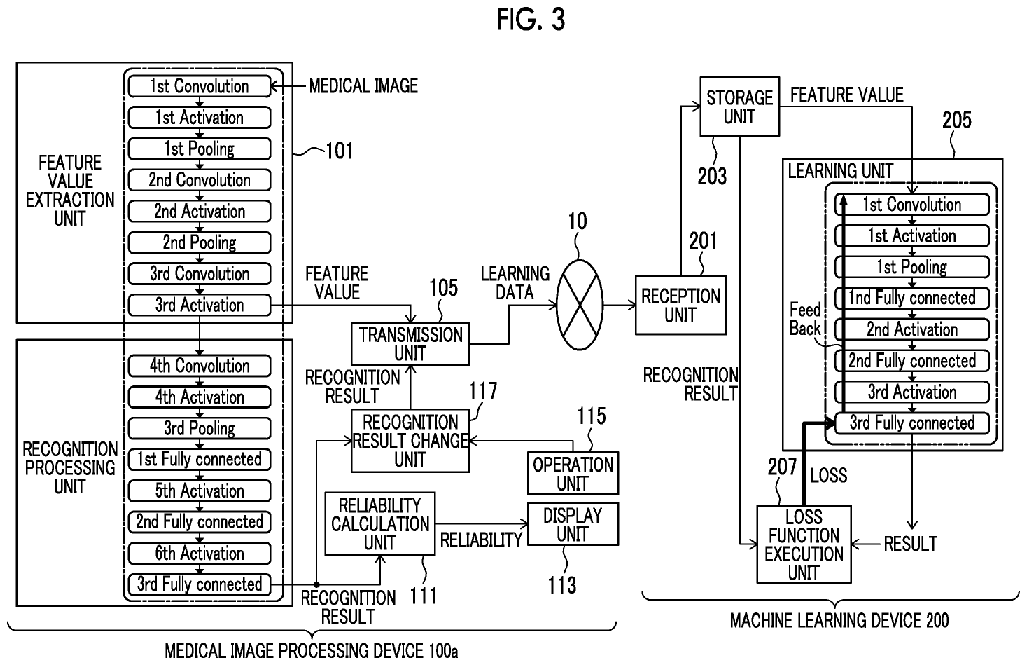

FIG. 3 is a block diagram showing a relationship between a medical image processing device 100a and a machine learning device 200 according to a second embodiment of the present invention and configurations thereof. The medical image processing device 100a according to the second embodiment is different from the medical image processing device 100 according to the first embodiment in that the medical image processing device 100a includes a reliability calculation unit 111, a display unit 113, an operation unit 115, and a recognition result change unit 117. The configuration according to the second embodiment is identical to the configuration of the first embodiment exception for the aforementioned configuration, and thus, the description of matters identical or equivalent to those of the first embodiment will be simplified or omitted.

The reliability calculation unit 111 included in the medical image processing device 100a according to the present embodiment calculates the reliability of the recognition result output from the recognition processing unit 103. In a case where the recognition result is, for example, a score of the likelihood of a lesion, the reliability calculation unit 111 calculates a low reliability value in a case where the score is within a range of a predetermined threshold value. The display unit 113 displays the reliability for each recognition result calculated by the reliability calculation unit 111.

The operation unit 115 is means for the user of the medical image processing device 100a to operate the recognition result change unit 117. The operation unit 115 is, specifically, a trackpad, a touch panel, or a mouse. The recognition result change unit 117 changes the recognition result output from the recognition processing unit 103 according to an instruction content from the operation unit 115. The change of the recognition result includes an input of the recognition result created by an external device of the medical image processing device 100a in addition to the correction of the recognition result output from the recognition processing unit 103. The external device also includes a device that determines the recognition result from a biopsy result. The user of the medical image processing device 100a changes the recognition result of which the reliability is lower than the threshold value, for example.

The transmission unit 105 according to the present embodiment associates the recognition result output from the recognition processing unit 103 or the recognition result changed by the recognition result change unit 117 with the feature value extracted by the feature value extraction unit 101, and transmits, as the learning data of the machine learning device 200 to the machine learning device 200, the feature value and the recognition result or the changed recognition result via the communication network 10.

In a case where the recognition result included in the learning data transmitted from the medical image processing device 100a to the machine learning device 200 is changed, the result output from the learning unit 205 and the changed recognition result are input to the loss function execution unit 207 of the machine learning device 200. Therefore, the loss function execution unit 207 calculates a loss useful for learning, and the loss is fed back into the learning unit 205. Accordingly, efficient learning is performed.

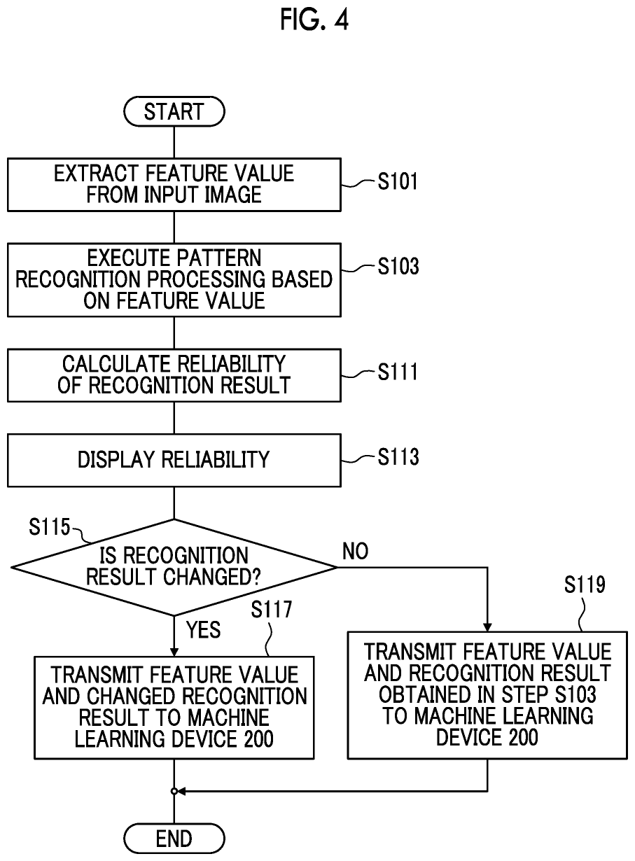

Next, an operation of the medical image processing device 100a according to the second embodiment will be described with reference to FIG. 4. FIG. 4 is a flowchart showing processing performed by the medical image processing device 100a according to the second embodiment.

As shown in FIG. 4, the feature value extraction unit 101 of the medical image processing device 100a extracts the feature value from the input data of the medical image by using the first network model described in the first embodiment (step S101). Subsequently, the recognition processing unit 103 performs the pattern recognition processing of the image by using the first network model based on the feature value obtained in step S101 (step S103). Subsequently, the reliability calculation unit 111 calculates the reliability of the recognition result obtained in step 5103 (step 5111). Subsequently, the display unit 113 displays the reliability obtained in step S111 (step S113).

Next, in a case where the recognition result obtained in step S103 is changed by the recognition result change unit 117 (YES in step S115), the transmission unit 105 associates the changed recognition result with the feature value obtained in step S101, and transmits, as the learning data of the machine learning device 200, the feature value and the changed recognition result to the machine learning device 200 (step S117). In a case where the recognition result obtained in step S103 is not changed by the recognition result change unit 117 (NO in step S115), the transmission unit 105 associates the recognition result obtained in step S103 with the feature value obtained in step S101, and transmits, as the learning data of the machine learning device 200, the feature value and the recognition result to the machine learning device 200 (step S119).

As described above, in the present embodiment, in a case where the reliability of the recognition result output from the recognition processing unit 103 of the medical image processing device 100a is low, an opportunity to change the recognition result is given, and the feature value and the changed recognition result are provided as the learning data to the machine learning device 200. Since there is a high possibility that the result output from the learning unit 205 input to the loss function execution unit 207 of the machine learning device 200 is different from the changed recognition result and the loss useful for learning is calculated, efficient learning is performed by feeding the loss back into the learning unit 205. As described above, the medical image processing device 100a can provide the learning data that can be efficiently learned by the machine learning device.

### Third Embodiment

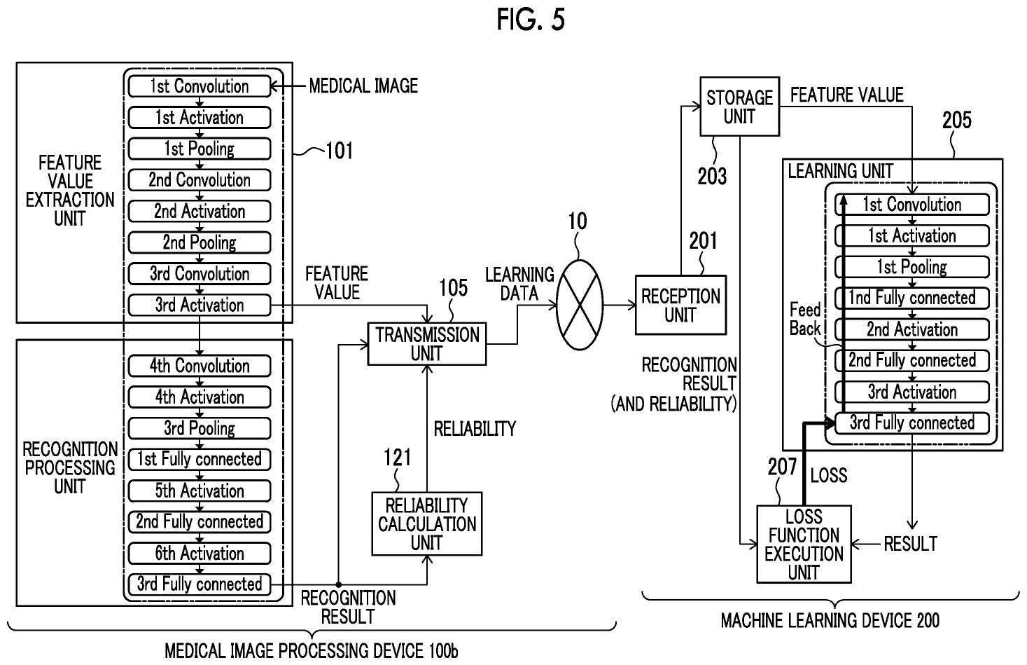

FIG. 5 is a block diagram showing a relationship between a medical image processing device 100b and a machine learning device 200 according to the third embodiment of the present invention and configurations thereof. The medical image processing device 100b according to the third embodiment is different from the medical image processing device 100 according to the first embodiment in that the medical image processing device 100b includes a reliability calculation unit 121. The configuration according to the second embodiment is identical to the configuration of the first embodiment exception for the aforementioned configuration, and thus, the description of matters identical or equivalent to those of the first embodiment will be simplified or omitted.

The reliability calculation unit 121 included in the medical image processing device 100b according to the present embodiment calculates the reliability of the recognition result output from the recognition processing unit 103. In a case where the recognition result is, for example, a score of the likelihood of a lesion, the reliability calculation unit 121 calculates a low reliability value in a case where the score is within a range of a predetermined threshold value.

The transmission unit 105 according to the present embodiment associates the recognition result output by the recognition processing unit 103 and the reliability calculated by the reliability calculation unit 121 with the feature value extracted by the feature value extraction unit 101 to obtain the feature value and at least one of the recognition result or the reliability is transmitted to the machine learning device 200 via the communication network 10 as learning data of the machine learning device 200. The transmission unit 105 transmits the feature value and the recognition result as the learning data in a case where the reliability is equal to or larger than a predetermined value, and transmits the feature value, the recognition result, and the reliability as the learning data in a case where the reliability is smaller than the predetermined value.

In a case where the learning data transmitted from the medical image processing device 100b to the machine learning device 200 includes the reliability, the learning unit 205 of the machine learning device 200 performs the pattern recognition processing of the image from the feature value and outputs the result as in the first embodiment. The loss function execution unit 207 calculates the loss by inputting, as parameters, the result output from the learning unit 205 and the recognition result with a low reliability to the loss function. The loss is usefully used for learning by being fed back into the learning unit 205.

In the present embodiment, in a case where the reliability is included in the learning data, since the reliability of the recognition result input to the loss function execution unit 207 is low, there is sufficient room for learning even though the recognition result is input as the parameter with no change. That is, the loss function execution unit 207 and the learning unit 205 continue to calculate and learn the loss such that an output score of the learning unit 205 becomes a highest value. For example, in a case where there are three classifications of “A”, “B”, and “C” and a correct answer is “A”, the learning unit 205 performs learning such that the output score is “(A, B, C)=(1.0, 0.0, 0.0)”. However, the score of the recognition result input to the loss function execution unit 207 when the reliability is low is, for example, “(A, B, C)=(0.5, 0.3, 0.2)”, and the score has a gap as compared with the output score “(A, B, C)=(1.0, 0.0, 0.0)” of the learning unit 205. This gap is calculated as a loss, and the loss is usefully used for learning by being fed back into the learning unit 205.

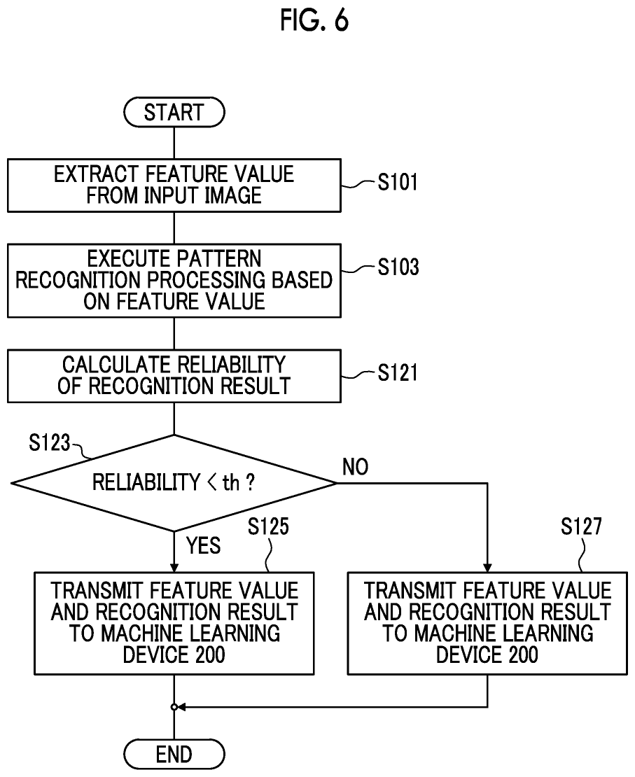

Next, an operation of the medical image processing device 100b according to the third embodiment will be described with reference to FIG. 6. FIG. 6 is a flowchart showing processing performed by the medical image processing device 100b according to the third embodiment.

As shown in FIG. 6, the feature value extraction unit 101 of the medical image processing device 100b extracts the feature value from the input data of the medical image by using the first network model described in the first embodiment (step S101). Subsequently, the recognition processing unit 103 performs the pattern recognition processing of the image by using the first network model based on the feature value obtained in step S101 (step S103). Subsequently, the reliability calculation unit 121 calculates the reliability of the recognition result obtained in step S103 (step S121).

Subsequently, in a case where the reliability obtained in step 5121 is smaller than a predetermined value th (YES in step S123), the transmission unit 105 associates the recognition result obtained in step S103 and the reliability obtained in step S121 with the feature value obtained in step S101, and transmits, as the learning data of the machine learning device 200, the feature value, the recognition result, and the reliability to the machine learning device 200 (step S125). In a case where the reliability obtained in step S121 is equal to or larger than the predetermined value th (NO in step S123), the transmission unit 105 associates the recognition result obtained in step S103 with the feature value obtained in step S101, and transmits, as the learning data of the machine learning device 200, the feature value and the recognition result to the machine learning device 200 (step S127).

As described above, in the present embodiment, in a case where the reliability of the recognition result output from the recognition processing unit 103 of the medical image processing device 100b is low, since the learning data to be provided to the machine learning device 200 includes the reliability and the loss is calculated on the assumption that the recognition result has low reliability, the machine learning device 200 performs efficient learning by feeding the loss back into the learning unit 205. In this manner, the medical image processing device 100b can provide the learning data that can be efficiently learned by the machine learning device.

### Fourth Embodiment

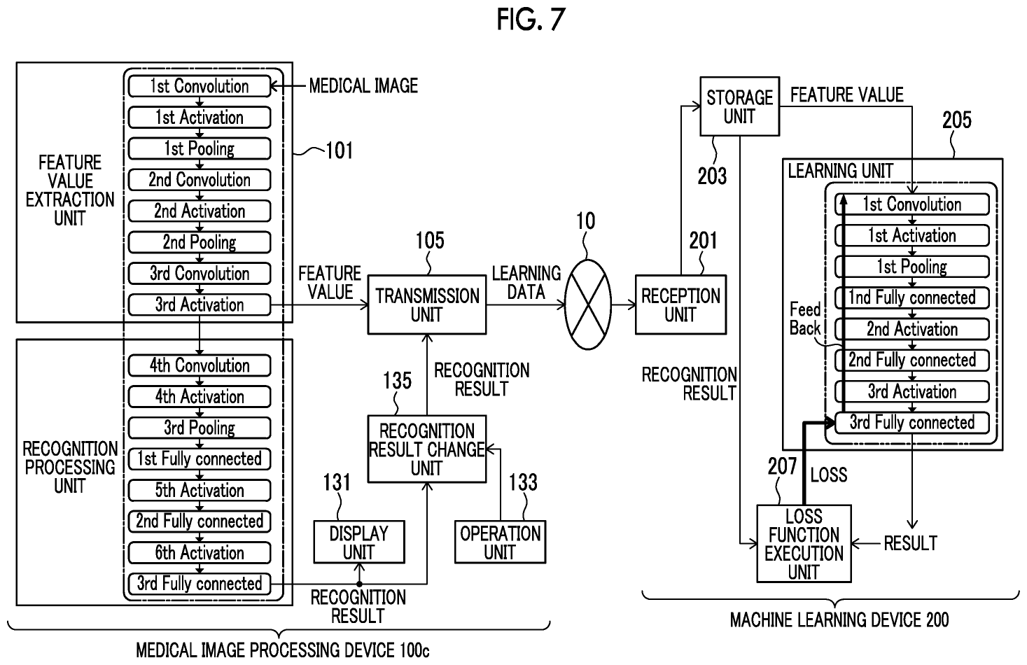

FIG. 7 is a block diagram showing a relationship between a medical image processing device 100c and a machine learning device 200 according to the fourth embodiment of the present invention, and configurations thereof. The medical image processing device 100c according to the fourth embodiment is different from the medical image processing device 100 according to the first embodiment in that the medical image processing device 100c includes a display unit 131, an operation unit 133, and a recognition result change unit 135. The configuration according to the second embodiment is identical to the configuration of the first embodiment exception for the aforementioned configuration, and thus, the description of matters identical or equivalent to those of the first embodiment will be simplified or omitted.

The display unit 131 included in the medical image processing device 100c of the present embodiment displays the reliability of each recognition result output from the recognition processing unit 103. The operation unit 133 is means for the user of the medical image processing device 100c to operate the recognition result change unit 135. The operation unit 133 is specifically a trackpad, a touch panel, or a mouse.

The recognition result change unit 135 changes the recognition result output from the recognition processing unit 103 according to an instruction content from the operation unit 133. The change of the recognition result includes an input of the recognition result created by an external device of the medical image processing device 100c in addition to the correction of the recognition result output from the recognition processing unit 103. The external device also includes a device that determines the recognition result from a biopsy result. The user of the medical image processing device 100c changes the recognition result in a case where the recognition result is incorrect, for example.

The transmission unit 105 according to the present embodiment associates the recognition result output from the recognition processing unit 103 or the recognition result changed by the recognition result change unit 135 with the feature value extracted by the feature value extraction unit 101, and transmits, as the learning data of the machine learning device 200, the feature value and the recognition result or the changed recognition result to the machine learning device 200 via the communication network 10.

In a case where the recognition result included in the learning data transmitted from the medical image processing device 100c to the machine learning device 200 is changed, the result output from the learning unit 205 and the changed recognition result are input to the loss function execution unit 207 of the machine learning device 200. Therefore, the loss function execution unit 207 calculates a loss useful for learning, and the loss is fed back into the learning unit 205. Accordingly, efficient learning is performed.

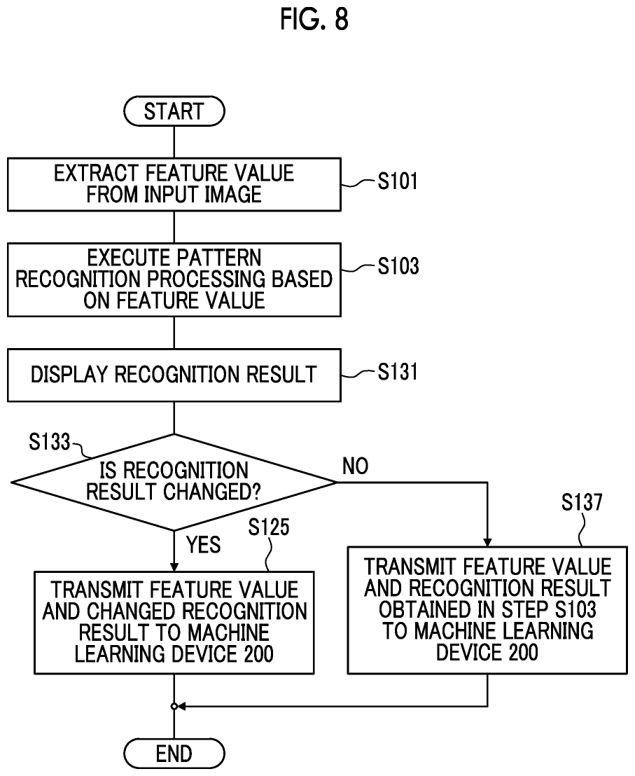

Next, an operation of the medical image processing device 100c according to the fourth embodiment will be described with reference to FIG. 8. FIG. 8 is a flowchart showing processing performed by the medical image processing device 100c according to the fourth embodiment.

As shown in FIG. 8, the feature value extraction unit 101 of the medical image processing device 100c extracts the feature value from the input data of the medical image by using the first network model described in the first embodiment (step S101). Subsequently, the recognition processing unit 103 performs the pattern recognition processing of the image by using the first network model based on the feature value obtained in step S101 (step S103). Subsequently, the display unit 131 displays the recognition result obtained in step 5103 (step S131).

Subsequently, in a case where the recognition result obtained in step 5103 is changed by the recognition result change unit 135 (YES in step S133), the transmission unit 105 associates the changed recognition result with the feature value obtained in step 5101, and transmits, as the learning data of the machine learning device 200, the feature value and the changed recognition result to the machine learning device 200 (step S135). In a case where the recognition result obtained in step 5103 is not changed by the recognition result change unit 135 (NO in step S133), the transmission unit 105 associates the recognition result obtained in step S103 with the feature value obtained in step S101, and transmits, as the learning data of the machine learning device 200, the feature value and the recognition result to the machine learning device 200 (step S137).

As described above, in the present embodiment, an opportunity to change the recognition result output from the recognition processing unit 103 of the medical image processing device 100c is given, and the feature value and the changed recognition result are provided as the learning data to the machine learning device 200. Since there is a high possibility that the result output from the learning unit 205 input to the loss function execution unit 207 of the machine learning device 200 is different from the changed recognition result and the loss useful for learning is calculated, efficient learning is performed by feeding the loss back into the learning unit 205. As described above, the medical image processing device 100c can provide the learning data that can be efficiently learned by the machine learning device.

As described above, a medical image processing device disclosed in the present specification is a medical image processing device that generates learning data to be provided to a machine learning device that performs learning by using data related to an image from a medical image. The medical image processing device comprises a feature value extraction unit that extracts a feature value from the medical image, a recognition processing unit that performs recognition processing of an image based on the feature value, and a providing unit that provides, as the learning data, the feature value and a result of the recognition performed by the recognition processing unit to the machine learning device.

The feature value is anonymized information.

The anonymized feature value is information obtained by removing at least a part of coordinate information of the medical image.

The medical image processing device further includes a reliability calculation unit that calculates reliability from the recognition result, and a recognition result change unit that changes the result of the recognition performed by the recognition processing unit. The providing unit provides the feature value and the result of the recognition changed by the recognition result change unit to the machine learning device in a case where the reliability is smaller than a threshold value.

The medical image processing device further includes a reliability calculation unit that calculates reliability from the recognition result. The providing unit provides the feature value and at least one of the recognition result or the reliability to the machine learning device in a case where the reliability is smaller than a threshold value.

The medical image processing device further includes a recognition result change unit that changes the result of the recognition performed by the recognition processing unit. The providing unit provides the feature value and the result of the recognition performed by the recognition processing unit or the result of the recognition changed by the recognition result change unit to the machine learning device.

The providing unit performs data compression on the feature value by image compression processing using image characteristics, and provides the feature value obtained by the data compression to the machine learning device.

The providing unit transmits the feature value obtained by the data compression to the machine learning device.

The feature value extraction unit extracts the feature value by using a network model having a layer structure in which neural networks are stacked in multiple layers.

The neural network is a convolutional neural network.

A machine learning device disclosed in the present specification is a machine learning device that performs learning by using data related to an image to be provided form a medical image processing device. The medical image processing device includes a feature value extraction unit that extracts a feature value from the medical image, a recognition processing unit that performs recognition processing of an image based on the feature value, and a providing unit that provides, as learning data, the feature value and a result of the recognition performed by the recognition processing unit to the machine learning device. The machine learning device performs the learning by using the learning data.

### EXPLANATION OF REFERENCES

100, 100a , 100b, 100c: medical image processing device

101: feature value extraction unit

103: recognition processing unit

105: transmission unit

111, 121: reliability calculation unit

113, 131: display unit

115, 133: operation unit

117, 135: recognition result change unit

200: machine learning device

201: reception unit

203: storage unit

205: learning unit

207: loss function execution unit

10: communication network

What is claimed is:

1. A medical image processing device comprising:
a processor configured to
extract a feature value from a medical image;
perform recognition processing of the medical image based on the feature value; and
provide the feature value and a result of the recognition to a machine learning device that performs learning using the feature value and the result of the recognition as the learning data.

2. The medical image processing device according to claim 1,
wherein the feature value is anonymized information.

3. The medical image processing device according to claim 1,
wherein the feature value is anonymized information obtained by removing at least a part of coordinate information of the medical image.

4. The medical image processing device according to claim 1,
wherein the processor further configured to
change the result of the recognition according to reliability calculated from the recognition result; and
provide the feature value and the changed result of the recognition to the machine learning device in a case where the reliability is smaller than a threshold value.

5. The medical image processing device according to claim 2,
wherein the processor further configured to
change the result of the recognition according to reliability calculated from the recognition result; and
provide the feature value and the changed result of the recognition to the machine learning device in a case where the reliability is smaller than a threshold value.

6. The medical image processing device according to claim 3,
wherein the processor further configured to
change the result of the recognition according to reliability calculated from the recognition result; and
provide the feature value and the changed result of the recognition to the machine learning device in a case where the reliability is smaller than a threshold value.

7. The medical image processing device according to claim 1,
wherein the processor further configured to
calculate reliability from the recognition result, and
provide the feature value and at least one of the recognition result or the reliability to the machine learning device in a case where the reliability is smaller than a threshold value.

8. The medical image processing device according to claim 2,
wherein the processor further configured to
calculate reliability from the recognition result, and
provide the feature value and at least one of the recognition result or the reliability to the machine learning device in a case where the reliability is smaller than a threshold value.

9. The medical image processing device according to claim 3,
wherein the processor further configured to
calculate reliability from the recognition result, and
provide the feature value and at least one of the recognition result or the reliability to the machine learning device in a case where the reliability is smaller than a threshold value.

10. The medical image processing device according to claim 1,
wherein the medical image processing device further configured to
change the result of the recognition; and
provide the feature value and the result of the recognition or the changed result of the recognition to the machine learning device.

11. The medical image processing device according to claim 2,
wherein the medical image processing device further configured to
change the result of the recognition; and
provide the feature value and the result of the recognition or the changed result of the recognition to the machine learning device.

12. The medical image processing device according to claim 3,
wherein the medical image processing device further configured to
change the result of the recognition; and
provide the feature value and the result of the recognition or the changed result of the recognition to the machine learning device.

13. The medical image processing device according to claim 1,
wherein the processor configured to
perform data compression on the feature value using image characteristics, and
provide the feature value obtained by the data compression to the machine learning device.

14. The medical image processing device according to claim 2,
wherein the processor configured to
perform data compression on the feature value using image characteristics, and
provide the feature value obtained by the data compression to the machine learning device.

15. The medical image processing device according to claim 3,
wherein the processor configured to
perform data compression on the feature value using image characteristics, and
provide the feature value obtained by the data compression to the machine learning device.

16. The medical image processing device according to claim 4,
wherein the processor configured to
perform data compression on the feature value using image characteristics, and
provide the feature value obtained by the data compression to the machine learning device.

17. The medical image processing device according to claim 13,
wherein the processor configured to transmit the feature value obtained by the data compression to the machine learning device.

18. The medical image processing device according to claim 1,
wherein the processor configured to extract the feature value by using a network model having a layer structure in which neural networks are stacked in multiple layers.

19. The medical image processing device according to claim 18,
wherein the neural network is a convolutional neural network.

20. A machine learning system comprising:
a processor configured to
extract a feature value from a medical image;
perform recognition processing of the medical image based on the feature value, a
perform the learning by using the feature value and a result of the recognition as a learning data.
